(19) United States
(12) Patent Application Publication
(10) Pub. No.: US 2022/0011281 A1
(43) Pub. Date: Jan. 13, 2022

(54) ION-EXCHANGE CHROMATOGRAPHY SYSTEM FOR ANALYZING ELECTROLYTE SOLUTION, METHOD OF QUANTITATIVE ANALYSIS OF LITHIUM SALTS IN ELECTROLYTE SOLUTION, AND PREPARATION METHOD FOR ELECTROLYTE SOLUTION USING SAME

(71) Applicant: SOULBRAIN CO., LTD., Seongnam-si (KR)

(72) Inventors: Dong-Ho JO, Seongnam-sI (KR); Sung Kyun YU, Seongnam-si (KR)

(21) Appl. No.: 17/475,372

(22) Filed: Sep. 15, 2021

Related U.S. Application Data
(63) Continuation of application No. PCT/KR2020/004781, filed on Apr. 8, 2020.

(30) Foreign Application Priority Data
Apr. 8, 2019 (KR) 10-2019-0040887

(51) Int. Cl. G01N 30/96; H01M 10/48; G01N 30/64; G01N 30/04

(52) U.S. Cl. CPC G01N 30/96; H01M 10/484; G01N 2030/042; G01N 30/04; G01N 2030/645; G01N 30/64

(57) ABSTRACT

The present disclosure relates to a nanoscale thin film structure and implementing method thereof, more specifically nanoscale thin film structure of which target structure is designed with quantized thickness and a method to implement the nanoscale thin film structure by which the performance of the manufactured nanodevice can be implemented the same as the designed performance, thereby applicable to high sensitivity high performance electronic/optical sensor devices.

### CROSS-REFERENCE TO RELATED APPLICATIONS

This application claims priority under 35 U.S.C. § 119 to Korean Patent Application No. 10-2019-0040887, filed on Apr. 8, 2019, in the Korean Intellectual Property Office, the disclosure of which is incorporated herein by reference in its entirety.

### TECHNICAL FIELD

The present invention relates to an ion-exchange chromatography system for analyzing electrolyte, a method of quantitative analysis of lithium salts in an electrolyte, and a preparation method for an electrolyte using the same, more specifically, relates to an ion-exchange chromatography system for analyzing electrolyte, a method of quantitative analysis of lithium salts in an electrolyte, and a preparation method for an electrolyte using same, in which an adjusting lead time is reduced drastically due to quantitative analysis for a plurality of lithium salts in an electrolyte end product without the interference of additives, productivity is improved due to the elimination of an intermediate inspection step, and production output management, analytical reliability, and customer satisfaction can be improved.

### BACKGROUND

The continuous growth of the battery-related industry is expected due to the recent expansion of the electric vehicle market and the advancement of energy storage devices, and the supply of electrolyte products is expected to increase accordingly.

Lithium secondary battery is a representative battery for the above-described batteries, and its demand is increasing rapidly. Lithium secondary battery is a battery that stores direct current power through the repeated operation of charging and discharging, and supplies electricity to outside as required, and has a configuration in which a positive electrode and a negative electrode with a separator interposed therebetween are positioned in a container filled with an electrolyte. The positive electrode and the negative electrode are manufactured by spraying a mixture of active material, a conductive agent, and a binder to a current collector, and the active material functions as a chemical for generating electrical energy and exporting to an external circuit.

Since the electrolyte is a material that directly affects the efficiency of the battery and its performance is greatly affected by temperature, composition, concentration, presence and/or amount of impurities, etc., it should be prepared under optimized conditions, and it is necessary to check whether the prepared electrolyte satisfies the optimized conditions.

Among the optimization conditions of the electrolyte, the content of metal salts is particularly important, and as a method for quantitative analysis of metal salt components, conventionally, Inductively Coupled Plasma-Optical Emission Spectrometer (ICP-OES), High-performance Liquid Chromatography (HPLC), Nuclear Magnetic Resonance (NMR), etc. have been used.

However, in the case of ICP-OES, although the metal salt input in the intermediate step can be quantified, it is difficult to accurately analyze the metal salts included in the final electrolyte due to limitations of the analysis method, non-separation, or interference of additives, HPLC has a limitation that it can detect only some limited components, and NMR has a problem that accurate quantitative analysis is difficult since only mixed data is obtained.

Therefore, there is an urgent need to develop a quantitative analysis method for electrolyte components that can separate all metal salts to be measured in a final electrolyte product, omit a plurality of intermediate inspection steps by excluding the interference of other additives, and greatly increase analysis reliability.

Prior art: Korean Patent Publication Laid-open No. 2010-0096907.

### SUMMARY

In order to solve the problems of the prior art, it is an object of the present invention to provide an ion-exchange chromatography system for analyzing electrolyte, a method of quantitative analysis of lithium salts in an electrolyte, and a preparation method for an electrolyte using the same, in which an adjusting lead time is reduced drastically due to quantitative analysis for a plurality of lithium salts in an electrolyte end product without the interference of additives, productivity is improved due to the elimination of an intermediate inspection step, and production output management, analytical reliability, and customer satisfaction can be improved.

The above and other objects of the present invention can be achieved by the present invention described below.

To achieve the objects above, the present invention provides an ion-exchange chromatography system for separating and quantifying a plurality of lithium salts contained in an electrolyte comprising: an ion-exchange column; a mobile phase; and an electrical conductivity detector, characterized in that the mobile phase comprises sodium carbonate (NaCO₃) of 1 to 10 millimolar concentration (mM), sodium hydrogen carbonate concentration (NaHCO₃) of 0.5 to 8 millimolar (mM), 15 to 40% by weight of acetonitrile, and balance water.

In the present disclosure, a detector is not particularly limited if it is an electrochemical detector or a spectroscopy detector that is commonly used in the art to which the present invention belongs, and is preferably an electrical conductivity detector, which is easy to use, economical, quick, and precise. It has the effect that precise lithium salt quantification is possible.

Furthermore, the present invention provides a quantitative analysis method of lithium salts in an electrolyte comprising the steps of preparing a standard electrolyte; calibrating the standard electrolyte using the ion-exchange chromatography system according to the present invention; and quantifying the standard electrolyte sample using the ion-exchange chromatography system.

Also, the present invention provides an electrolyte preparation method comprising the ion-exchange chromatography system according to the present invention.

According to the present invention, it is possible to provide an ion-exchange chromatography system for analyzing electrolyte, a method of quantitative analysis of lithium salts in an electrolyte, and a preparation method for an electrolyte using the same, in which an adjusting lead time is reduced drastically due to quantitative analysis for a plurality of lithium salts in an electrolyte end product without the interference of additives, productivity is improved due to the elimination of an intermediate inspection step, and production output management, analytical reliability, and customer satisfaction can be improved.

### BRIEF DESCRIPTION OF THE DRAWINGS

The above and other aspects, features, and advantages of certain preferred embodiments of the present disclosure will be more apparent from the following description taken in conjunction with the accompanying drawings, in which:

FIG. 1 is a chromatogram of a conductivity detector, which is obtained from Example 3 according to the present invention.

FIG. 2 is a chromatogram of a conductivity detector, which is obtained from Example 5 according to the present invention.

FIG. 3 is a comparative chromatogram of a conductivity detector, which is obtained from Example 3 according to the present invention, in which the temperature conditions are adjusted for 20° C. and 40° C.

### DETAILED DESCRIPTION

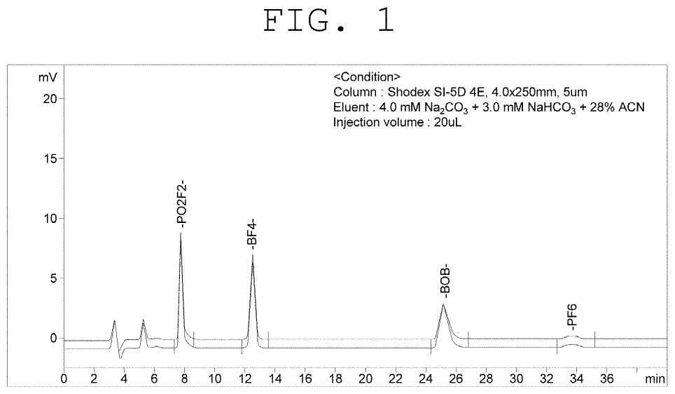

Hereinafter, an ion-exchange chromatography system for analyzing an electrolyte, a method of quantitative analysis of lithium salts in an electrolyte, and a preparation method for an electrolyte using same according to the present disclosure will be described in detail. FIG. 1 is a view showing a nanoscale thin film according to an embodiment of the present disclosure.

The inventors of the present invention came to know that, when a mobile phase containing sodium carbonate (NaCO₃), sodium hydrogen carbonate (NaHCO₃), acetonitrile (ACN), and water in a certain weight ratio is applied to a predetermined ion-exchange chromatography system, the content of a plurality of lithium salts can be accurately analyzed without any overlapping or interfering with additives and have been devoted to completing the present invention base on that finding.

The present invention relates to an ion-exchange chromatography system for separating and quantifying a plurality of lithium salts contained in an electrolyte comprising an ion exchange column, a mobile phase, and an electrical conductivity detector, and the mobile phase comprises sodium carbonate (NaCO₃) of 1 to 10 millimolar concentration (mM), sodium hydrogen carbonate concentration (NaHCO₃) of 0.5 to 8 millimolar (mM), 15 to 40% by weight of acetonitrile, and balance water. Since a plurality of lithium salts can be analyzed without any overlapping between ions or interfering with additives, lead time is reduced drastically, productivity is improved due to skipping intermediate inspection steps, and production output management, analytical reliability, and customer satisfaction can be improved drastically.

Each component comprising the ion-exchange chromatography system according to the present disclosure will be described in detail as follows.

For example, the plurality of lithium salts is at least two selected from the group consisting of LiPO₂F₂, LiBF₄, LiBOB, and LiPF₆, preferably all of them. Since the content of most or all lithium salts usable in the final electrolyte product can be measured, an intermediate inspection step can be omitted, and the analysis reliability of the final electrolyte product is greatly improved.

The detector is not particularly limited if it is a detector that is commonly used in the art to which the present invention belongs.

The ion exchange column is an anion exchange column, preferably comprises the quaternary ammonium ligand in a stationary phase, more preferably is SHODEX SI-50 4E, which is effective in obtaining accurate and reproducible quantitative analysis results because it has excellent resolution for the ions to be measured and can exclude the interference of additives.

For example, the mobile phase comprises sodium carbonate (NaCO₃) of 3.5 to 4.5 millimolar concentration (mM), sodium hydrogen carbonate concentration (NaHCO₃) of 2.5 to 3.5 millimolar (mM), 25 to 30% by weight of acetonitrile, and balance water, preferably, sodium carbonate 3.7 to 4.3 millimolar concentration, sodium hydrogen carbonate concentration of 2.7 to 3.3 millimolar concentration, 26 to 29% by weight of acetonitrile, and balance water, and more preferably, sodium carbonate 3.9 to 4.1 millimolar concentration, sodium hydrogen carbonate concentration of 2.9 to 3.1 millimolar concentration, 27 to 29% by weight of acetonitrile, and balance water, in this scope, a plurality of lithium salts, especially Li salt can be analyzed without the interference of additives, lead time is reduced drastically, analytical reliability, and customer satisfaction can be improved drastically.

A quantitative analysis method of lithium salts in an electrolyte according to the present invention comprises the steps of preparing a standard electrolyte; calibrating the standard electrolyte using the ion-exchange chromatography system according to the present invention; and quantifying the standard electrolyte sample using the ion-exchange chromatography system. With these steps, the content of a plurality of lithium salts in the final electrolyte product can be measured without the interference of additives, an intermediate inspection step can be omitted, and production output management, analytical reliability, and customer satisfaction can be improved.

In this description, a standard electrolyte is a reagent of which exact components and amounts are already known and is used as a standard to determine the amount of lithium salt in the electrolyte sample and is prepared by first preparing a reference electrolyte in an exact amount and by mass diluting it to a concentration similar to that of an electrolyte sample.

In this disclosure, calibrating means measuring the components and amounts of the standard electrolyte by a corresponding analysis method, by which a calibration curve is drawn to obtain the correlation between the concentration of the standard electrolyte and the signal strength of the detector.

In this disclosure, quantifying means measuring the components and amounts of the electrolyte sample by the same analysis method as the standard electrolyte. After measuring the electrolyte sample, the concentration can be calculated based on the measured signal value according to the calibration curve, and the amount of each component can be measured.

For example, the standard electrolyte is a solution prepared by primary mass dilution of the reference electrolyte with 5 to 15 times of an electrolyte solvent and secondary mass dilution with 30 to 300 times in a mobile phase, preferably, by primary mass dilution of the reference electrolyte with 7 to 13 times of an electrolyte solvent and secondary mass dilution with 50 to 250 times in a mobile phase, more preferably, by primary mass dilution of the reference electrolyte with 9 to 11 times of an electrolyte solvent and secondary mass dilution with 80 to 200 times in a mobile phase, and in this scope, without the interference of additives, exact measurement results for the content of lithium salts to be measured in the final electrolyte products.

In the present disclosure, mass dilution means a dilution method to dilute a solution with a solvent by adding the solvent in multiples of the mass of the solution and is a different concept from volumetric dilution in which a solvent is added in multiples of the volume of the solution to be diluted. Here, the multiple may be a positive real number or an integer. When the mass dilution is employed in the present invention, the standard deviation compared to the volumetric dilution can be greatly reduced, therefore, the analysis precision and the analysis reliability are greatly improved.

In the present disclosure, the method further comprises the step of storing the primarily mass-diluted reference electrolyte at 4° C. or lower, preferably 0 to 4° C., more preferably 2 to 4° C., and within the scope, there is an effect of obtaining a reproducible and precise result value for the content of lithium salt to be measured in the final electrolyte product.

For example, the reference electrolyte can comprise at least two lithium salts selected from the group consisting of LiPO₂F₂, LiBF₄, LiBOB, and LiPF₆, preferably all of them. Since the content of most or all lithium salts usable in the final electrolyte product can be measured, an intermediate inspection step can be omitted, and the analysis reliability of the final electrolyte product is greatly improved.

For example, the electrolyte solvent comprises at least one selected from the group consisting of EC (Ethylene Carbonate), DEC (Diethyl Carbonate), DMC (Dimethyl Carbonate), and EMC (Ethyl methyl Carbonate), preferably, a compound solvent comprises EC, DEC, and EMC, which has excellent electrolyte performance and can obtain reproducible and precise results for the content of lithium salt to be measured in the final electrolyte product.

The standard electrolyte comprises additives that are contained or can be contained, for example, at least one of silyl borate compounds and organic halo phosphine compounds, which has excellent electrolyte performance and can obtain reproducible and precise results for the content of lithium salt to be measured in the final electrolyte product.

The electrolyte standard sample is prepared by diluting 500 to 1500 times, preferably 700 to 1300 times, more preferably 900 to 1100 times of the electrolyte mass in a mobile phase, and, within the scope, there is an effect of obtaining a reproducible and precise result value for the content of lithium salt to be measured in the final electrolyte product.

The contents which are included in the standard electrolyte and the electrolyte sample can be similar, preferably identical, by which obtaining a reproducible and precise result value for the content of lithium salt to be measured in the final electrolyte product is possible.

The temperature of the column in the calibration step is, for example, 15 to 45° C., preferably 18 to 30° C., more preferably 18 to 25° C., within this scope, no meaningful difference is in the temperature and analysis is simple.

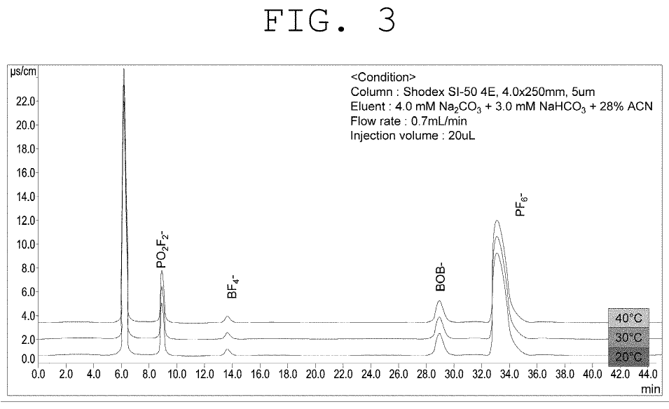

FIG. 3 is a comparative chromatogram of a conductivity detector, which is obtained from Example 3 according to the present invention, in which the temperature conditions are adjusted for 20° C. and 40° C., it shows that no meaningful difference exists by temperature condition on the spectrum.

An electrolyte preparation method comprises the ion-exchange chromatography system according to the present invention. Since a plurality of lithium salts can be analyzed without any overlapping between ions or interfering with additives, lead time is reduced drastically, productivity is improved due to skipping intermediate inspection steps, and production output management, analytical reliability, and customer satisfaction can be improved drastically.

The electrolyte preparation method can comprise, for example, a quantitative analysis method for lithium salts in an electrolyte.

Sample injection devices, column conditions, suppressors, IC consumables, IC accessories, and other quantitative analysis methods that are not described in this description are not particularly limited if they are applicable in the art to which the present invention belongs and can be appropriately selected according to a function and a requirement.

Preferable embodiments and drawings are provided below, that is for illustrative purposes only, and other specific forms can be easily modified without changing the technical spirit or essential features of the present invention for a person having ordinary skill in the art to which the present invention pertains, and all changes or modified forms derived from the meaning and scope of the claims and their equivalent concepts should be interpreted as being included in the scope of the present invention.

### Example

### <Preparation of Electrolyte>

In a clean tank, silyl borate-based compounds and organic halo phosphine-based compounds in a total amount of 0.1 to 10% by weight as additives and LiPF₆ and LiBF₄ in a total amount of 0.6 to 2 M as a lithium salt are added and mixed with an organic solvent which is a mixture of ethylene carbonate (EC), ethyl methyl carbonate (EMC) and diethyl carbonate (DEC) in a volume ratio of 3:5:2, to prepare a first-stage metal salt solution.

0.01 to 5 wt % of LiPO₂F₂ and 0.1 to 5 wt % of fluoroethylene carbonate (FEC) were added and mixed to the first-stage metal salt solution to prepare a second-stage metal salt solution.

0.1 to 3 wt % of LiBoB was added and mixed to the second-stage metal salt solution to prepare the final electrolyte product.

### Comparative Example No. 1

A quantitative analysis was performed for the first stage metal salt solution, the second stage metal salt solution, and the final electrolyte product by the method described in Table 1 below, and the results are shown in Table 1. ICP-OES (Inductively Coupled Plasma-Optical Emission Spectrometer) was used for the atomic analysis.

TABLE No. 1

| | | | Adjusting |
|---|---|---|---|
| Classification | Sample | Method of Analysis | Time (h) |
| Comparative | First-stage | 1) Sampling and Atomic | 1 |
| Example 1 | metal salt | analysis for Li, B | |
| | solution | 2) Calculating content of | |
| | | LiBF₄ | |
| | | 3) Calculating remainder | |
| | | as LiPF₆ | |
| | Second-stage | 1) Sampling and Atomic | 44.5 |
| | metal salt | analysis for Li | |
| | solution | 2) Calculating as LiPO₂F₂ | |
| | Final | 1) Complete analysis and | 100 |
| | Electrolyte | atomic analysis for B¹⁾ | |
| | Product | 2) Calculating as LiBOB | |

| | |
|---|---|
| Total Adjusting Time | 145.5 |

¹⁾Unavailable for separate analysis of lithium salt in the final electrolyte product.

As shown in Table 1, when the electrolyte product was quantitatively analyzed using a conventional elemental analysis method (Comparative Example 1), there were problems in that a specific element had to be selected as representing the content of respective lithium salt, the manufacturing time for the electrolyte product was extended since a quantitative analysis is required whenever raw materials are input, re-verification is impossible for respective lithium salt, readjusting was impossible even if a problem was found in the final electrolyte product.

### Examples No. 1 to 5

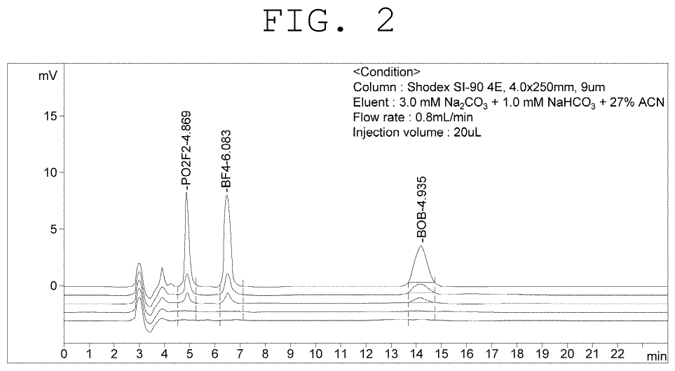

The prepared electrolyte products were quantitatively analyzed using an anion exchange chromatography analysis device coupled with an electrical conductivity detector (940 Profic IC, manufactured by Metrohm) under the conditions shown in Table 2 below, and the results are shown in Table 2 and FIGS. 1 and 2.

In the following results, “separation” means whether the peaks of ions were overlapped between the ions to be measured, the mark Δ indicates that two or three ions out of the ions of PO₂F₂⁻, BOB⁻, BF₄⁻ and PF₆⁻ were separated without overlapping, and O indicates that all the ions of PO₂F₂⁻, BOB⁻, BF₄⁻ and PF₆⁻ were separated. Also, “interference” means whether the peaks of ions to be measured were interfered with an additive, the mark Δ indicates that two or three ions out of the ions of PO₂F₂⁻, BOB⁻, BF₄⁻ and PF₆⁻ have not interfered, and X indicates that all the ions of PO₂F₂⁻, BOB⁻, BF₄⁻ and PF₆⁻ have not interfered.

TABLE 2

| | Column | Concentration of Eluent | | | | |
|---|---|---|---|---|---|---|
| | (Temp.: | | | ACN | | Inter- |
| Examples | 30° C.) | Na₂CO₃ | NaHCO₃ | (wt %) | Separation | ference |
| Example | SI-50 4E | 3.0 mM | 2.0 mM | 28% | ○ | Δ |
| 1 | | | | | | |
| Example | | 3.0 mM | 3.0 mM | 28% | ○ | X |
| 2 | | | | | | |
| Example | | 4.0 mM | 3.0 mM | 28% | ○ | X |
| 3 | | | | | | |
| Example | | 5.0 mM | 3.0 mM | 28% | Δ | Δ |
| 4 | | | | | | |
| Example | SI-90 4E | 3.0 mM | 1.0 mM | 27% | Δ | Δ |
| 5 | | | | | | |

As shown in Table 2, when quantitative analysis is performed for an electrolyte using the ion exchange chromatography system according to the present invention, separation and quantification of two or more components such as PO₂F₂⁻ and BF₄⁻ were possible, and especially, in the case of Example No. 2 and 3 where the SI-50 4E column is used and/or the concentration of Na₂CO₃ is in the range of 3.0 to 4.0 mM, it was confirmed that separation and quantification of four or more components PO₂F₂⁻, BOB⁻, BF₄⁻ and PF₆⁻ were possible. Furthermore, As shown in FIG. 1, in the case of Example 3, the ion peaks of PO₂F₂⁻, BOB⁻, BF₄⁻ and PF₆⁻ ions in the final electrolyte product were separated on the spectrum, and it was confirmed that there was no interference of additives. Also, as shown in FIG. 2, in the case of Example 5, the ion peaks of PO₂F₂⁻ and PF₆⁻ in the final electrolyte product were separated on the spectrum, and there was no interference of additives, but it was difficult to find out the peak of PF6⁻.

In conclusion, it was confirmed that, when an electrolyte is prepared by the ion exchange chromatography according to the present invention, an adjusting lead time is reduced drastically due to quantitative analysis for a plurality of lithium salts in a final electrolyte product without the interference of additives as in the Comparative Example No. 1, the elimination of an intermediate inspection step, and adjustment of content ration in the final electrolyte product. Also, production output management, analytical reliability, and customer satisfaction can be improved.

What is claimed is:

1. An ion-exchange chromatography system for separating and quantifying a plurality of lithium salts contained in an electrolyte comprising:
an ion-exchange column;
a mobile phase; and
an electrical conductivity detector,
characterized in that the mobile phase comprises sodium carbonate (NaCO₃) of 1 to 10 millimolar concentration (mM), sodium hydrogen carbonate concentration (NaHCO₃) of 0.5 to 8 millimolar (mM), 15 to 40% by weight of acetonitrile, and balance water.

2. The ion-exchange chromatography system according to claim 1,
wherein the plurality of lithium salts are at least two selected from the group consisting of LiPO₂F₂, LiBF₄, LiBOB, and LiPF₆.

3. The ion-exchange chromatography system according to claim 1,
wherein the ion exchange column is an anion exchange column.

4. The ion-exchange chromatography system according to claim 3,
wherein the anion exchange column comprises the quaternary ammonium ligand in a stationary phase.

5. The ion-exchange chromatography system according to claim 4,
wherein the anion exchange column is SHODEX SI-50 4E.

6. The ion-exchange chromatography system according to claim 1,
wherein the mobile phase comprises sodium carbonate (NaCO₃) of 3.5 to 4.5 millimolar concentration (mM), sodium hydrogen carbonate concentration (NaHCO₃) of 2.5 to 3.5 millimolar (mM), 25 to 30% by weight of acetonitrile, and balance water.

7. A quantitative analysis method of lithium salts in an electrolyte comprising the steps of:
preparing a standard electrolyte;
calibrating the standard electrolyte using the ion-exchange chromatography system according to claim 1; and
quantifying the standard electrolyte sample using the ion-exchange chromatography system.

8. The method according to claim 7,
wherein the standard electrolyte is prepared by primary mass dilution of reference electrolyte with 5 to 15 times of an electrolyte solvent and secondary mass dilution with 30 to 300 times in a mobile phase.

9. The method according to claim 8,
wherein the method further comprises the step of storing the primarily mass-diluted reference electrolyte at 4° C. or lower.

10. The method according to claim 8,
wherein the reference electrolyte comprises at least two lithium salts selected from the group consisting of LiPO₂F₂, LiBF₄, LiBOB, and LiPF₆.

11. The method according to claim 7,
wherein the electrolyte solvent comprises at least one selected from the group consisting of EC (Ethylene Carbonate), DEC (Diethyl Carbonate), DMC (Dimethyl Carbonate), and EMC (Ethyl methyl Carbonate).

12. The method according to claim 7,
wherein the standard electrolyte comprises at least one of silyl borate compounds and organic halo phosphine compounds.

13. The method according to claim 7,
wherein the electrolyte standard sample is prepared by diluting 500 to 1500 times of the electrolyte mass in a mobile phase.

14. The method according to claim 7,
wherein the components included in the standard electrolyte and those included in the electrolyte sample are identical.

15. An electrolyte preparation method comprising the ion-exchange chromatography system according to claim 1.
